(19) United States
(12) Patent Application Publication
(10) Pub. No.: US 2005/0153703 A1
(43) Pub. Date: Jul. 14, 2005

(54) Method of allocating resources in telecommunications system transceiver, computer program, and telecommunications system

(76) Inventors: Markku Juntti, Oulu (FI); Ari Pouttu, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/748,672

(22) Filed: Dec. 31, 2003

(51) Int. Cl. H04B 7/00

(52) U.S. Cl. 455/452.2; 455/62; 455/63.1

(57) ABSTRACT

A method, a transceiver, a telecommunications system, and a computer program are provided. According to the invention, a sampled receive signal is generated from a receive signal. An interference level threshold is derived on the basis of an iterative statistical analysis of the sampled receive signal, and an interfered portion of a signal space is identified on the basis of a comparison of the sampled receive signal and the interference level threshold. In an embodiment, the transmit resources are reduced from the interfered portion of the signal space.

### FIELD

The invention relates to a method of allocating resources in a telecommunications system, a transceiver of a telecommunications system, a telecommunications system, and a computer program.

### BACKGROUND

Telecommunications signals are prone to interference caused by radio transmitters operating in the same signal space with the telecommunications system. The interference may contaminate a portion of the signal space, of which case the portion's capability of transferring telecommunications signals from a transmitter to a receiver may substantially be reduced.

In prior art, signal transmission is based on the assumption of a non-interfered signal space, and the entire signal space allocated to the signal transmission is used in the signal transmission.

The assumption of the non-interfered signal space may result in an inefficient use of transmit resources, since a portion of the transmission utilizes the interfered portion of the signal space. Therefore, it is desirable to consider techniques to overcome the problem of inefficient use of transmit resources.

### BRIEF DESCRIPTION OF THE INVENTION

An object of the invention is to provide an improved method, transceiver, telecommunications system, and computer program. According to an aspect of the invention, there is provided a method of allocating resources in a telecommunications system, wherein signals are transmitted over a signal space, the method including: generating a sampled receive signal from a receive signal; deriving an interference level threshold on the basis of an iterative statistical analysis of the sampled receive signal; identifying an interfered portion of the signal space on the basis of a comparison of the sampled receive signal and the interference level threshold; and reducing transmit resources from the interfered portion of the signal space.

According to a second aspect of the invention, there is provided a transceiver of a telecommunications system, wherein signals are transmitted over a signal space, the transceiver including: a sampling unit for generating a sampled receive signal from a receive signal; a deriving unit for deriving an interference level threshold on the basis of an iterative statistical analysis of the sampled receive signal; an identifying unit for identifying an interfered portion of the signal space on the basis of a comparison of the sampled receive signal and the interference level threshold; and a transmitting unit for transmitting information on the interfered portion of the signal space to a second transceiver.

According to a third aspect of the invention, there is provided a transceiver of a telecommunications system, wherein signals are transmitted over a signal space, the transceiver including: a sampling unit for generating a sampled receive signal from a receive signal; a deriving unit for deriving an interference level threshold on the basis of an iterative statistical analysis of the sampled receive signal; an identifying unit for identifying an interfered portion of the signal space on the basis of a comparison of the sampled receive signal and the interference level threshold; and a transmit resource allocation unit for reducing transmit resources from the interfered portion of the signal space.

According to a fourth aspect of the invention, there is provided a transceiver of a telecommunications system, wherein signals are transmitted over a signal space, the transceiver including: a receiving unit for receiving information on an interfered portion of the signal space from a second transceiver; and a transmit resource allocation unit for reducing transmit resources from the interfered portion of the signal space on the basis of the information.

According to a fifth aspect of the invention, there is provided a telecommunications system, wherein signals are transmitted over a signal space, the telecommunications system including: generating means for generating a sampled receive signal from a receive signal; deriving means for deriving an interference level threshold on the basis of an iterative statistical analysis of the sampled receive signal; identifying means for identifying an interfered portion of the signal space on the basis of a comparison of the sampled receive signal and the interference level threshold; and reducing means for reducing transmit resources from the interfered portion of the signal space.

According to a sixth aspect of the invention, there is provided a computer program for executing a computer process in a telecommunications system, wherein signals are transmitted over a signal space, the computer process comprising the steps of: receiving as input a sampled receive signal generated from a receive signal; deriving an interference level threshold on the basis of an iterative statistical analysis of the sampled receive signal; and identifying an interfered portion of the signal space on the basis of a comparison of the sampled receive signal and the interference level threshold; and outputting information on the interfered portion of the signal space.

According to a seventh aspect of the invention, there is provided a computer program for executing a computer process in a telecommunications system, wherein signals are transmitted over a signal space, the computer process comprising the steps of: receiving as input information on an interfered portion of the signal space; and reducing transmit resources from the interfered portion of the signal space on the basis of the information.

Preferred embodiments of the invention are described in the dependent claims.

The method, the transceiver, the telecommunications system, and the computer program provide several advantages.

The iterative statistical analysis provides an effective procedure for identifying the interfered portion of the signal space with a relatively small amount of required a priori information on the interference characteristics. The invention enables de-allocating transmit resources from transmitting signals to the interfered signal space, thus releasing transmit resources to be allocated to the non-interfered signal space.

### LIST OF DRAWINGS

In the following, the invention will be described in greater detail with reference to the preferred embodiments and the accompanying drawings, in which

FIG. 1 shows an example of the structure of a telecommunications system;

FIG. 2 shows an example of the structure of a transceiver; and

FIG. 3 illustrates an example of characteristics of a receive signal;

FIG. 4 illustrates a second example of characteristics of a receive signal;

FIG. 5 illustrates example of characteristics of a signal wherein an interfered portion is reduced;

FIG. 6A shows an example of an embodiment of a transceiver;

FIG. 6B shows a second example of an embodiment of a transceiver;

FIG. 6C shows a third example of an embodiment of a transceiver;

FIG. 6D shows an example of an embodiment of a deriving unit;

FIG. 7A shows an example of methodology according to embodiments of the invention;

FIG. 7B shows a second example of methodology according to embodiments of the invention, and

FIG. 7C shows a third example of methodology according to embodiments of the invention.

### DESCRIPTION OF EMBODIMENTS

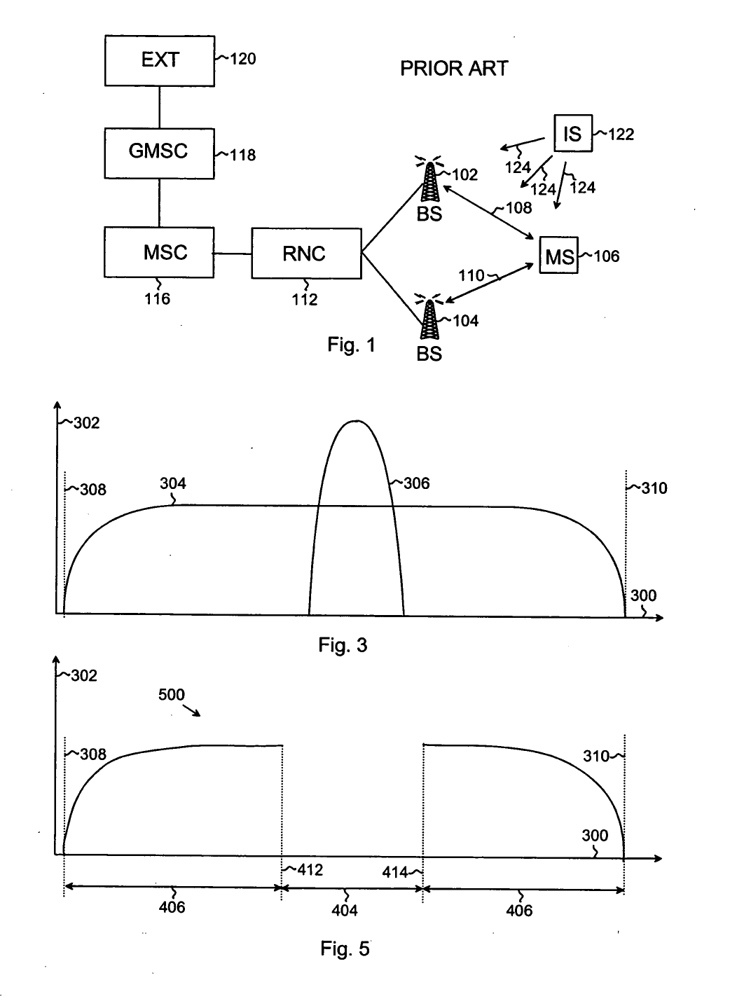

FIG. 1 illustrates an example of a simplified structure of a wireless telecommunications system to which the invention may be applied.

The telecommunications system is based on, for example, a GSM (Global System for Mobile Communications) radio access technology or WCDMA (Wideband Code Division Multiple Access) technology. The structure and function of the telecommunications system are known to a person skilled in the art, and only network elements relevant to the invention will be described.

In the example shown in FIG. 1, some of the network elements are presented in terms of the GSM terminology using circuit-switched network elements without restricting applications of the invention to the GSM system.

The telecommunications system comprises a mobile switching centre (MSC) 116 enabling circuit-switched signalling in the telecommunications system.

The telecommunications system may also comprise a gateway mobile services switching centre 118 (GMSC), which provides circuit-switched connections between the core network comprising the mobile switching centre 116 and the gateway mobile services switching centre 118, and external networks (EXT) 120, such as a public land mobile network (PLMN) or a public switched telephone network (PSTN).

The mobile switching centre 116 controls a radio access network, which comprises at least one radio network controller (RNC) 112 and a base station (BS) 102, 104 controlled by the radio network controller 112. The radio network controller 112 represents a network element, which acts as an interface between the core network and the radio access network. The base station 102, 104 characterizes a network element, which implements the radio interface for transferring telecommunication signals 108, 110 between the radio access network and the mobile station 106. The invention is not, however, restricted to the presented structure of the telecommunications system, but may be applied to any telecommunications system.

The telecommunications system may further comprise a mobile station 106 for providing a user with access to the telecommunications system. The mobile station 106 may comprise conventional components, including wireless modems, processors with software, memory, a user interface, and a display. The structure and functions of the mobile station 106 are known to a person skilled in the art, and the description is limited to details relevant to the present solution.

FIG. 1 further shows an interference source 122, which may transmit an interference signal 124, which may interfere with the telecommunication signal 108, 110. The interference is typically based on an electromagnetic disturbance in the radio frequency range applied by the telecommunications system.

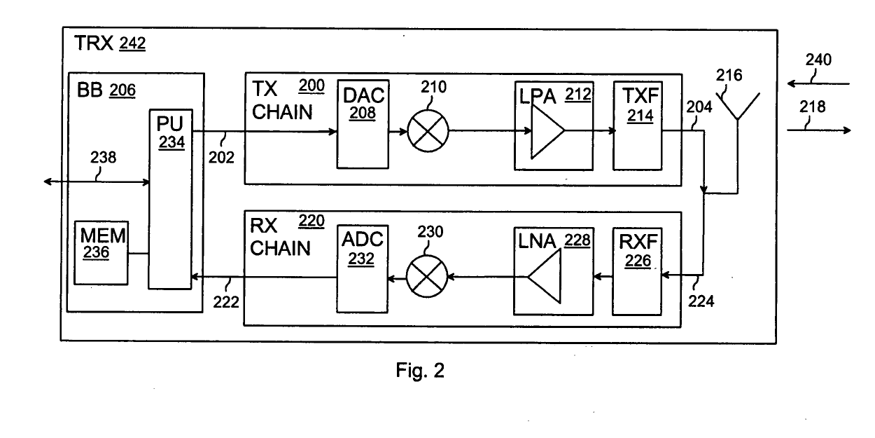

FIG. 2 illustrates an example of the structure of a transceiver 242, which may be used in implementing the present solution. The transceiver 242 may locate in the base station 102, 104 and/or in the mobile station 106.

The transceiver 242 includes an antenna unit 216 for converting a receive signal 240 into a receive radio frequency antenna signal 224, which is inputted into a receive chain 220. The receive signal 240 may include components of the telecommunications signal 108, 110 and of the interference signal 124.

The receive chain 220 converts the receive radio frequency antenna signal 224 into a sampled receive signal 222, which is further inputted into the base band unit 206.

The receive chain 220 may further include a receive filter unit 226 connected to the antenna unit 216, for attenuating undesired frequency components from the radio frequency receive antenna signal 224.

The receive chain 220 may further include a receive amplifier unit 228, such as a low noise amplifier, connected to the receive filter unit 226, for amplifying the radio frequency receive signal 224.

The receive chain 220 may further include a down-converter 230 for down-converting an amplified radio frequency receive signal received from the amplifier unit 228 into an analogue base band receive signal.

The analogue base band receive signal is sampled in an analogue-to-digital converter 232, which outputs the resulting sampled receive signal 222 into the base band unit 206.

The transceiver 242 may further include a transmit chain 200 for converting a digital transmit base band signal 202 received from the base band unit 206 into a radio frequency transmit antenna signal 204.

The transmit chain 200 may further include a digital-to-analogue converter 208 for converting the digital transmit base band signal 202 into an analogue base band transmit signal.

The transmit chain 200 may further include an up-converter 210 connected to the digital-to-analogue converter 208, for converting the analogue base band signal into a radio frequency transmit signal.

The radio frequency transmit signal may be amplified in an amplifier unit 212, such as a linear power amplifier.

The undesired frequency components of an amplified radio frequency transmit signal may further be attenuated in a transmit filter unit 214, which outputs the radio frequency transmit antenna signal 204 to the antenna unit 216. The antenna unit 216 converts the radio frequency transmit antenna signal 204 into a transmit signal 218. The transmit filter unit 214 and the receive filter unit 226 may form a diplexer filter.

The base band unit 206 may include a processing unit 234, such as a digital signal processor or an FPGA (Field Programmable Gate Array), for executing computer processes. The processing unit 234 may further receive and/or transmit digital signals 238 from the higher layers of the telecommunications system.

The base band unit may 206 may further include a memory unit 236 connected to the processing unit 234, for storing data and software for the use of the processing unit 234.

In an embodiment, the transceiver 242 includes a plurality of transmit chains 200, a plurality of receive chains 220, and a plurality of antenna units 216, thus enabling multi-antenna transmission and reception.

With reference to FIG. 3, characteristics of the receive signal 240 are illustrated in terms of the telecommunication signal presentation 304 of the telecommunication signal 108, 110 and the interference signal presentation 306 of the interference signal 124, presented in a chosen signal space dimension. A specific representation of the telecommunication signal 108, 110 and that of the interference signal 124 may be obtained by transforming a time domain receive signal 240 with a mathematical transformation, such as Fourier transform, Laplace transform, or wavelet transform, to an appropriate signal space dimension. The signal space dimension is typically chosen such that the characteristics of the telecommunication signal 108, 110 and those of the interference signal 124 may be efficiently identified.

The dimensions of a horizontal axis 300 and a vertical axis 302 depend on the chosen signal space dimension. The vertical axis 302 typically shows a quantity, which is proportional to receive power of the receive signal 240. In an embodiment, the vertical axis 302 shows the signal-to-interference ration (SIR) of the receive signal 240. In the case of complex variables, the vertical axis 302 may show signal magnitude. FIG. 3 further shows an upper signal space limit 310 and a lower signal space limit 308.

In an embodiment, the signal space dimension is a spatial dimension. In this case, the horizontal axis 300 may show a receive azimuth angle, a receive elevation angle, receive polarization, or another unit spatially distinguishable by the transceiver 242. The telecommunication signal presentation 304 may present a spatial power distribution of a received telecommunication signal 108, 110. The interference signal presentation 306 may indicate, for example, a specific direction of arrival and/or polarization of the interference signal 124 with respect to the telecommunications signal characteristics, when received by the transceiver 242. In this embodiment, the transceiver 242 typically includes a plurality of receive chains 220 and antenna units 216, thus enabling, for example, spatial diversity in reception.

Resources associated with spatial signal space dimension include for example, a number of antennas used for transmission and/or reception, a number of receive chains 220, a number of transmit chains 200, a number of transmit antenna beams, a number of receive antenna beams, and processing complexity in the base band unit 205.

In an embodiment, the signal space dimension is a temporal dimension. In this case, the horizontal axis 300 may show time in arbitrary units, and the signal space limits 308 and 310 may define a time interval, such as the duration of a frame or the duration of a bit. The interference signal presentation 306 may indicate temporal characteristics, such as temporal shape and time of occurrence of the interference signal 124. The telecommunication signal presentation 304 may characterize a time structure, such as a transmit time interval or the duration of a frame, for example, of the telecommunication signal 108, 110.

Resources associated with the temporal signal space dimension include, for example, scheduling resource, sampling units, and an analog-to-digital converter.

In an embodiment, the signal space dimension is a frequency dimension. In this case, the horizontal axis 300 is proportional to the signal frequency and the telecommunication signal presentation 306 may indicate power distribution of the telecommunication signal 108, 110. The interference signal presentation 306 may characterize the frequency distribution of the interference signal 124. The signal space limits 308 and 310 may define, for example, a telecommunication frequency band or a portion of the telecommunication frequency band.

Resources associated with the frequency signal space dimension include, for example, frequency resources, such as transmit power transmitted in a transmit frequency band, and a fast Fourier transform block. In an embodiment, the signal space dimension is a fractional frequency dimension. In this case, the telecommunication signal presentation 304 indicates the time-varying frequency content of the signal with a finer resolution of a desired portion, such as the interfered portion, of the receive signal 240. The resources associated with the fractional frequency dimension include resources associated with the spatial and frequency signal space dimensions, and a fractional frequency transform block.

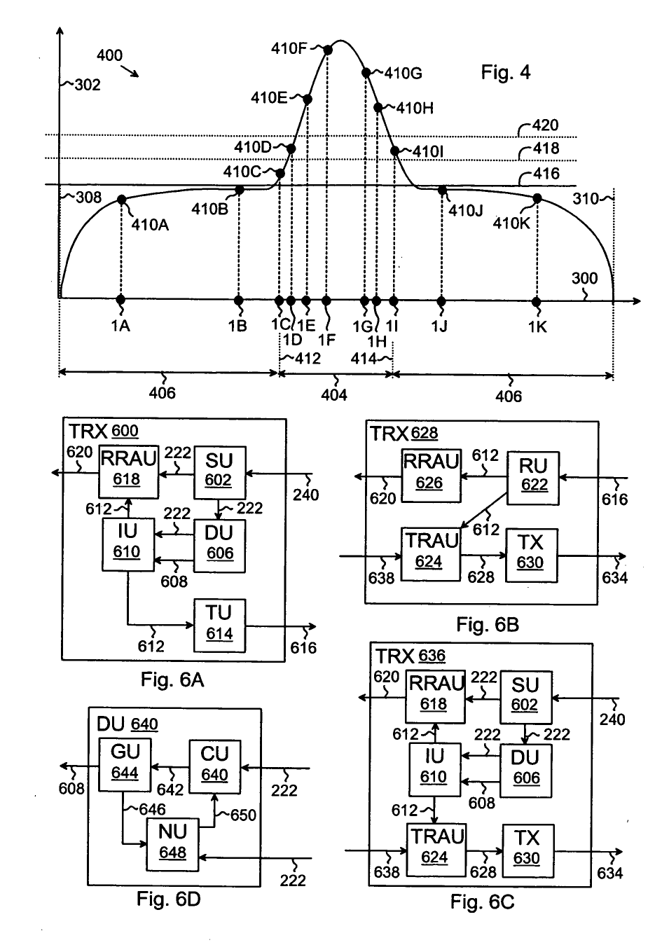

With reference to FIG. 4, a presentation 400 of the sampled receive signal 222 is shown as a superposition presentation of the telecommunications signal 108, 110 and of the interference signal 124.

FIG. 4 further shows a set of sample points 410A to 410K and corresponding x-ordinates 1A to 1K, of the sampled receive signal 222. For the ease of illustration, the x-ordinates 1A to 1K are distributed with unequal spacing on the horizontal axis 300. In an embodiment, the x-ordinates 1A to 1K are equally spaced.

The sample points 410A to 410K may also result from a mathematical transformation subjected to a set of sample points presented in another signal space dimension, such as the time domain.

An aspect of the present solution is to identify an interfered portion of the signal space on the basis of a comparison of the sampled receive signal 222 and an interference level threshold 416 derived on the basis of an iterative statistical analysis of the sampled receive signal 222.

In an iterative statistical analysis, a statistical characteristic quantity 420, such as mean, median or another relevant statistical quantity characterizing the average of a selection of the sample points 410A to 410K, is calculated. The sample points 410A to 410K of the selection are then compared with the statistical characteristic quantity 420, and sample points not satisfying statistical requirements, such as deviation of a sample point from the statistical characteristic quantity 420, are removed from the selection. A removal may be implemented, for example, by lowering the statistical weight of the removed sample point such that the removed sample point becomes insignificant in the statistical analysis.

In the iteration, a new value 418 for the statistical characteristic quantity is calculated for the new selection of the sample points, and the new selection is compared with the new value of the characteristic statistical quantity 418. Again, sample points not satisfying the statistical requirements are removed from the new selection.

The iteration procedure may be continued until a predefined condition is fulfilled. Such a condition may be, for example, a fixed number of iteration steps succeeded in the iteration, a number of sample points in a prevailing selection, a difference in the number of the sample points in successive iteration steps, a difference in the statistical characteristic quantity 418, 420 between successive iteration steps, or the standard deviation of the sample points in the selection from the statistical characteristics quantity 418, 420. The invention is not, however, restricted to the aforementioned conditions, but any condition characterizing a quality of the sample points in the prevailing selection may be used.

As a result of the iterative statistical analysis, the interference level threshold 416 is obtained from the characteristic statistical quantity 418, 420 of the last iteration step. It is also possible that the statistical characteristic quantity 418, 420 of the last iteration step is neglected, and the statistical characteristic quantity 418, 420 of the step prior to the last iteration step is used instead.

The identification of the interfered portion of the signal space may be based on a comparison of the sample points 410A to 410K with the interference level threshold 416. In FIG. 4, the interfered portion 404 of the signal space is defined by the sample points, which lie above the interference level threshold 416. In this case, the sample points 410C to 410I lying above the interference level threshold 416 are identified as interfered. Sample points 410A, 410B, 410J, 410K lying below the interference level threshold 416 define a non-interfered portion 406 of the signal space. The actual non-interfered portion 404 and the actual interfered portion 406 may be obtained from a set of x-ordinates 1A, 1B, 1J, 1K, and a set of x-ordinates 1C to 11, respectively.

It is also possible to express the interference portion 404 with an interfered portion lower limit 412 and an interference portion upper limit 414, between which the interfered portion 404 is confined.

The interfered sample points 410C to 410I may also be identified during the iteration procedure by assigning the sample points lying above the prevailing statistical quantity 418, 420 with a label indicating an interfered sample point. The set of the interfered sample points is then increased in the course of a converging iteration. It should be noted, however, that it is the location of the final interference threshold 416 that defines the interfered portion 406 of the signal space, and it is a matter of computational approach, whether to identify the interfered sample points 410C to 410I in the course of the iteration procedure, or as a final step after deriving the interference level threshold 416.

In an embodiment, the interference level threshold 416 may be contributed by a reliability factor characterizing statistics of the non-interfered portion 406 of the sampled receive signal 222. The reliability factor typically provides theoretical information on the reliability of making a separation between the interfered and non-interfered sample points. Let us denote the interference level threshold Q, the characteristic statistical quantity M, and the reliability factor R. The interference level threshold 416 may be written as
Q=MR. (1)

The reliability factor R may be obtained from a theoretical analysis of statistics of non-interfered receive signals. In an embodiment, the reliability factor is based on the assumption of Gaussian noise in the receive signal 240, thus leading to Rayleigh distribution of the magnitude spectrum. In this case, the reliability factor R may be expressed as

$$R = \frac{\sqrt{- ln ( 1 - {F}_{target} )}}{Γ ( 1.5 )} , \qquad ( 2 )$$

where Γ(1.5) is a gamma function with argument value 1.5, and F_{target} is the target value of the cumulative density function of a Rayleigh distributed variable. If F_{target} is set to 0.99, for example, 1% of the sample points 410A to 410K is incorrectly identified as interfered, and the characteristic statistical quantity, such as the mean of the non-interfered sample points 410A, 410B, 410J, 410K, is modified by R in order to provide the interference level threshold Q. It should be noted, that Eq. (1) may be applied during any step of the iteration procedure. In such a case, the sample points are compared with the prevailing interference level threshold, which may be represented by the vertical lines 418 and 420 in FIG. 4.

The iterative statistical analysis provides an efficient procedure to identify the interfered portion 404 of the signal space with a relatively small amount of a priori information on the interference.

With reference to FIG. 5, a representation 500 of a transmit signal 218 illustrates a situation, where the resources from the interfered portion 404 of the signal space are reduced.

In an embodiment, the signal space dimension is the temporal dimension, and the transmit signal 218 may be transmitted at a reduced power level during the time of interference.

In an embodiment, the signal space dimension is the spatial dimension, and the transmit signal 218 may be transmitted at a reduced power level to the direction and/or polarization of the interference signal 124. A transmit direction may be selected by adjusting transmit antenna weights so that a desired spatial distribution of the transmit signal 128 is obtained.

In an embodiment, the signal space dimension is the frequency dimension, and the transmit signal 218 may be transmitted at a reduced power level into the interfered portion 404 of the frequency band. The transmit frequency may be controlled by an FFT (Fast Fourier Transform) notch filter, for example.

It should be noted, that more than one signal space dimension may be processed simultaneously and more than one transmit resource may be reduced at a time. For example, the direction and the frequency distribution of the interference signal 124 may be identified simultaneously, and the transmit direction and/or polarization transmit signal, and the frequency distribution are chosen such that transmission to the interfered signal space 404 is avoided.

With reference to FIG. 6A, examples of embodiments of a transceiver 600 are shown.

The transceiver 600 includes a sampling unit 602 for generating a sampled receive signal 222 from the receive signal 240. The sampling unit 620 may include the antenna unit 216, a portion of the receive chain 220, and a portion of the processing unit 234.

The sampled receive signal 222 is inputted into a deriving unit 606, which derives the interference level threshold 416 on the basis of the iterative statistical analysis of the sampled receive signal 222.

With reference to FIG. 6D, in an embodiment, the deriving unit 640 includes a calculating unit 640 for calculating the mean 642 of the sampled receive signal 222. Furthermore, the deriving unit 640 includes a generating unit 644 connected to the calculating unit 640, for generating the interference level threshold 646 by using the mean 642, and the predefined reliability factor. The interference level threshold 646 is inputted into a neglecting unit 648, which neglects a portion of the sampled receive signal 222, the portion lying above the interference level threshold 416, in a succeeding iteration step. The neglecting unit 648 outputs the prevailing selection 650 of the sample points into the calculating unit 640 for further calculation of the mean. When the iteration is stopped, the generating unit 644 outputs the final value of the interference level threshold 608. The iteration may be stopped according to the aforementioned criteria, for example.

The iterative procedure described above provides with a relatively robust algorithm for making a separation between the interfered signal space 404 and the non-interfered signal space 406. The algorithm provides with relatively reliable results, when typically less than 90% of the sample points 410A to 410K are interfered. The invention is not, however, restricted to the given percentage figure, but may operate even when more than 90% of the sample points 410A to 410K are interfered.

The iterative procedure in this case is also called a CME (Consecutive Mean Excision) algorithm disclosed in “Consecutive Mean Excision Algorithm” by P. Henttu and S. Aromaa in IEEE 7^{th} Sym. on Spread Spectrum Tech. & Appl., Prague, Czech Republic, Sep. 2-5, 2002, which is hereby incorporated by reference.

With further reference to FIG. 6A, in an embodiment, the deriving unit 606 may further perform required mathematical transformations between different representations of the sampled receive signal 222.

The deriving unit 606, the calculating unit 640, the generating unit 644, and the neglecting unit 648 may be implemented with a processing unit 234 by using a digital signal processor and software, for example. It is known to one skilled in the art how to perform such programming.

In an embodiment, the deriving unit 606 is implemented with a Field Programmable Gate Array and appropriate programming information.

The deriving unit 606 provides interference level threshold information 608 and the sampled receive signal for an identifying unit 610, which identifies the interfered portion 404 of the signal space on the basis of a comparison of the sampled receive signal 222 and the interference level threshold 416. The identifying unit 610 outputs an information signal 612, which includes information on the interfered portion 404 of the signal space. The information may include, for example, the x-ordinates 1C to 1I of the interfered portion 404, pointers indicating said x-ordinates, or the interfered portion lower limit 412 and the upper limit 414.

If the temporal signal space dimension is considered, the identifying unit 610 may detect the duration of an interference pulse, and time interval between successive interference pulses, which duration and the time interval are used in reducing the transmit resources. In this case, the information signal 612 includes information on the duration and the time interval.

The identifying unit 610 may be implemented with a processing unit 234 by using a digital signal processor and software, for example.

In an embodiment, the identifying unit 610 is implemented with a Field Programmable Gate Array and appropriate programming information.

It should be noted, that deriving unit 606 and the identifying unit 610 may be implemented with a shared computer program, which identifies the interference sample points in the course of the iteration of the interference level threshold 416 into the final value.

In an embodiment of the invention, the transceiver 600 further includes a transmitting unit 614 connected to the identifying unit 610, for transmitting information on the interfered signal space 404 to a second transceiver, which includes means for reducing the transmit resources from the interfered portion of the signal space 404. The identifying unit 610 inputs the information signal 612 into the transmitting unit 614, which transmits the information signal to the second transceiver by using, for example, a control channel 616. The control channel typically provides transferring feedback information from the transceiver 600 to the second transceiver.

If the transceiver 600 locates in the base station 102, 104, the second transceiver may locate in the mobile station 106.

If the transceiver 600 locates in the mobile station 106, the second transceiver may locate in the base station 102, 104.

The transmitting unit 614 may be implemented, for example, with the transmit chain 200, the antenna unit 216, and a portion of the processing unit 234 shown in FIG. 2.

In an embodiment of the invention, the transceiver 600 further includes a receive resource allocation unit 618 for reducing receive resources from the interfered portion 404 of the signal space. The receive resources are, for example, receive antenna beams and receive frequency distribution. The receive resource allocation unit 618 may output an output signal 620 with similar characteristics to the representation 500 of the transmit signal 218 shown in FIG. 5.

With reference to FIG. 6B, examples of embodiments of a transceiver 628 are shown.

The transceiver 628 includes a receiving unit 622 for receiving information on the interfered portion 404 of the signal space from a second transceiver. The receiving unit 622 may be implemented with the receive chain 220, the antenna unit 216, and a portion of the processing unit 234.

The receiving unit 622 may receive, for example, a control channel 616 transmitted by the second transceiver, and extract the information signal 612 from the control channel 616.

The information signal 612 is inputted into a transmit resource allocation unit 624, which reduces the transmit resources from the interfered portion 404 of the signal space on the basis of the information carried by the information signal 612.

The transmit resource allocation unit 624 may be inputted with a payload signal 638, which is provided with transmit resources according to the information signal 612. The transmit resource allocation unit 624 outputs the payload signal 628, such as that shown in FIG. 5, into a transmitter unit 630, which converts the payload signal 628 into a transmit signal 634. The transmitter unit 630 may comprise the transmit chain 200 and the antenna unit 216.

The transmit resource allocation unit 624 may transform the representation of the payload signal 638 from one domain to another so that the transmit resource may be reduced appropriately. The transmit resource allocation unit 624 may adjust transmit parameters, such as antenna weights, and FFT filter pass band so that the payload signal transmission avoids using the interfered portion 404 of the signal space. The portions of the payload signal 638 located in the interfered portion of the signal space may be attenuated or excised.

In an embodiment, the transmit resource allocation unit 624 allocates the transmit resources to the non-interfered portion 406 of the signal space. The non-interfered portion 406 may be deduced from the information signal 612, for example. If the signal space dimension is the frequency dimension, for example, transmit power may be allocated to the non-interfered frequency region, thus conserving the overall information transfer capacity regardless of the decrease in the frequency resource. A similar case may occur with the spatial signal space dimension. More transmit power may be allocated to non-interfered directions and/or polarizations.

The transmit resource allocation unit 624 may be implemented with the processing unit 234 by using a digital signal processor and/or the FPGA and software, for example.

The transceiver 628 may further include a receive resource allocation unit 626 similar to that described in conjunction with FIG. 6A. However, in this case, the receiving unit 622 inputs the information signal 612 into the receive resource allocation unit 626.

The transceiver 600 and the transceiver 628 may form a telecommunications system, in which the transceiver 600 characterizes the interference, i.e. the interfered portion 404 of the signal space from the signal transmitted by transceiver 628. The transceiver 600 signals the information signal 612 to the transceiver 628 by using the control channel 616, for example. The transceiver 628 then reduces the transmit resources from the interfered portion 404 of the signal space.

With reference to FIG. 6C, examples of embodiments of a transceiver 636 are shown. In these embodiment, the transceiver includes the sampling unit 602, the deriving unit 606, the identifying unit 610, and the transmit resource allocation unit 624. In this embodiment, the interference characterization and the reduction of the transmit resources from the interfered portion 404 of the signal space are carried out in the same transceiver 636. The receive signal 240 may originate from the same transceiver from which the transmit signal 634 is transmitted.

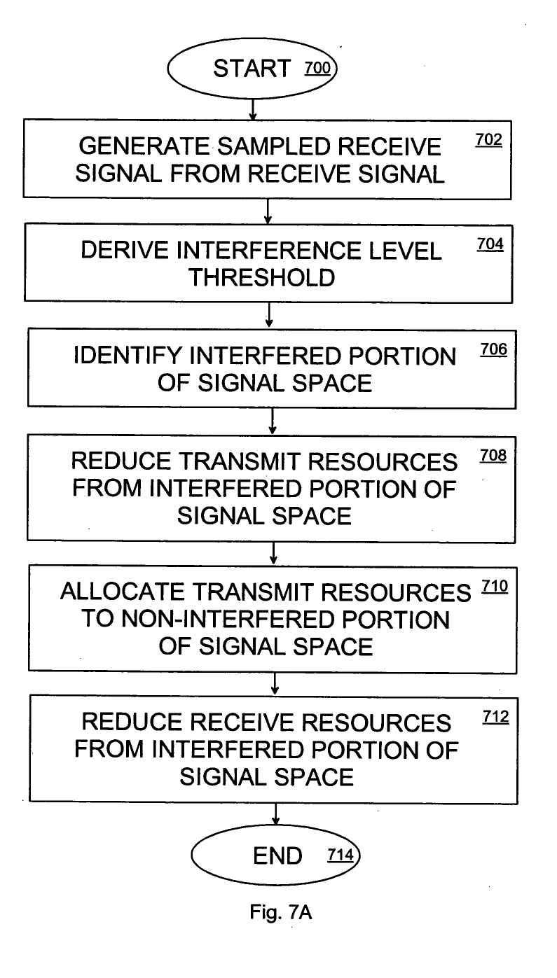

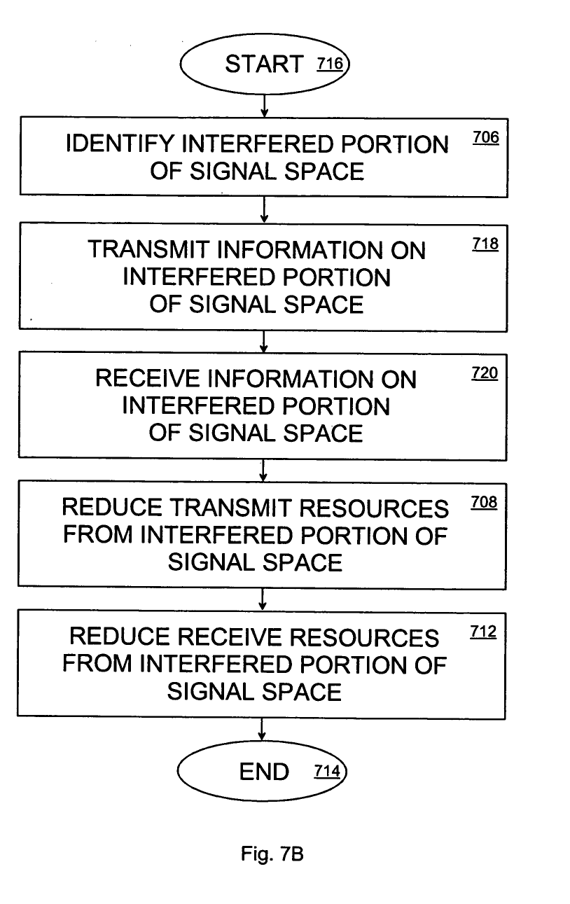

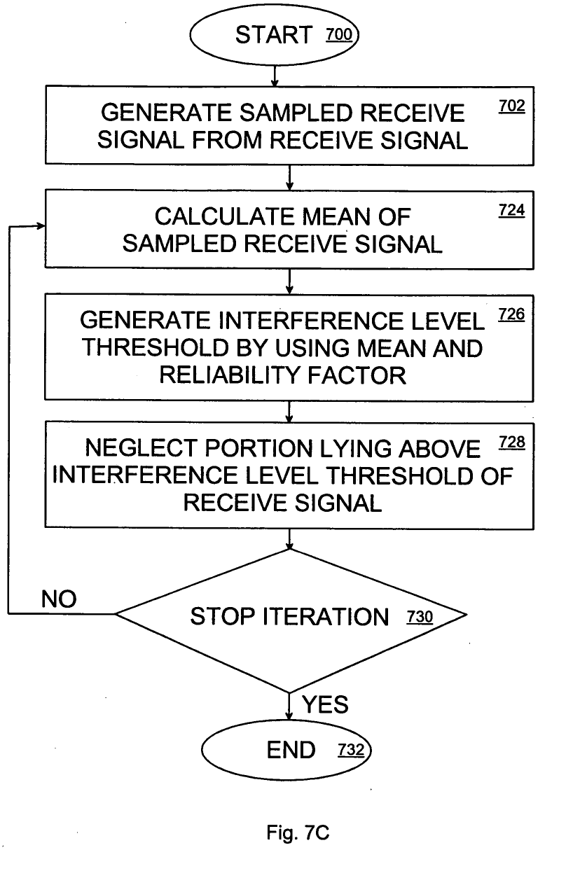

With reference to FIGS. 7A, 7B, and 7C, examples on methodology according to embodiments of the invention are shown.

In 700, the method is started.

In 702, the sampled receive signal 222 is generated from the receive signal 240.

In 704, the interference level threshold 416 is derived on the basis of the iterative statistical analysis of the sampled receive signal 222.

In 706, the interfered portion 404 of the signal space is identified on the basis of a comparison of the sampled receive signal 222 and the interference level threshold 416.

In 708 transmit resources are reduced from the interfered portion 404 of the signal space.

In 710, transmit resources are allocated to a non-interfered portion 406 of the signal space.

In 712, receive resources are reduced from the interfered portion 404 of the signal space.

In 714, the method ends.

With reference to FIG. 7B, the method starts in 716.

In 706, the interfered portion 404 of the signal space is identified on the basis of a comparison of the sampled receive signal 222 and the interference level threshold 416.

In 718, information on the interfered portion 404 of the signal space is transmitted.

In 720, the information is received.

In 708 transmit resources are reduced from the interfered portion 404 of the signal space on the basis of the information.

In 712, receive resources are reduced from the interfered portion 404 of the signal space.

In 714, the method ends.

With reference to FIG. 7C, the method starts in 700.

In 702, the sampled receive signal 222 is generated from the receive signal 240.

In 724, 726, and 728, the interference level threshold 416 is derived by using at least one iteration step, wherein in 724, the mean of the sampled receive signal 222 is calculated; in 726, the interference level threshold 416 is derived by using the mean, and a predefined reliability factor characterizing statistics of a non-interfered portion 406 in the sampled receive signal 222; and in 728, a portion of the sampled receive signal 222 is neglected, the portion lying above the interference level threshold.

In 730, a decision is made whether to continue iteration. If the iteration is continued, the sequence of steps of 724, 726, and 728 is repeated. Otherwise, the method ends in 732.

In an aspect, the invention provides a computer program for executing a computer process comprising method steps described above. The computer program may be stored in a data carrier, such as a CD (Compact Disc), a hard drive, a diskette, a portable memory unit. The computer program may further be transferred with en electric signal in a data network, such as the Internet.

Even though the invention is described above with reference to an example according to the accompanying drawings, it is clear that the invention is not restricted thereto but it can be modified in several ways within the scope of the appended claims.

1. A method of allocating resources in a telecommunications system, wherein signals are transmitted over a signal space, the method including:
generating a sampled receive signal from a receive signal;
deriving an interference level threshold on the basis of an iterative statistical analysis of the sampled receive signal;
identifying an interfered portion of the signal space on the basis of a comparison of the sampled receive signal and the interference level threshold; and
reducing transmit resources from the interfered portion of the signal space.

2. The method of claim 1, wherein the step of deriving the interference level threshold includes at least one iteration step comprising:
calculating the mean of the sampled receive signal;
generating the interference level threshold by using the mean, and a predefined reliability factor characterizing statistics of a non-interfered portion in the sampled receive signal; and
neglecting a portion of the sampled receive signal, the portion lying above the interference level threshold.

3. The method of claim 1, further including reducing receive resources from the interfered portion of the signal space.

4. The method of claim 1, wherein the step of reducing the transmit resources includes at least one element from the group comprising: attenuating a portion of transmit signal, the portion being located in the interfered portion of the signal space; excising a portion of the transmit signal, the portion being located in the interfered portion of the signal space.

5. The method of claim 1, further including transmitting information on the interfered portion of the signal space; and
receiving the information; and
reducing the transmit resources from the interfered portion of the signal space on the basis of the information.

6. The method of claim 1, further including transmitting information on the interfered portion of the signal space; and
receiving the information; and
reducing the receive resources from the interfered portion of the signal space on the basis of the information.

7. The method of claim 1, further including allocating transmit resources to a non-interfered portion of the signal space.

8. The method of claim 1, wherein the signal space includes at least one dimension selected from the group comprising: a spatial dimension, a temporal dimension, a frequency dimension, a fractional frequency dimension.

9. A transceiver of a telecommunications system, wherein signals are transmitted over a signal space, the transceiver including:
a sampling unit for generating a sampled receive signal from a receive signal;
a deriving unit for deriving an interference level threshold on the basis of an iterative statistical analysis of the sampled receive signal;
an identifying unit for identifying an interfered portion of the signal space on the basis of a comparison of the sampled receive signal and the interference level threshold; and
a transmitting unit for transmitting information on the interfered portion of the signal space to a second transceiver.

10. The transceiver of claim 9, wherein the deriving unit is configured to perform an iterative procedure including tasks of:
calculating the mean of the sampled receive signal;
generating the interference level threshold by using the mean, and a predefined reliability factor characterizing statistics of a non-interfered portion in the sampled receive signal; and
neglecting a portion of the sampled receive signal, the portion lying above the interference level threshold.

11. The transceiver of claim 9, further including a receive resource allocation unit connected to the identifying unit, for reducing receive resources from the interfered portion of the signal space.

12. The transceiver of claim 9, wherein the signal space includes at least one dimension selected from the group comprising: a spatial dimension, a temporal dimension, a frequency dimension, a fractional frequency dimension.

13. A transceiver of a telecommunications system, wherein signals are transmitted over a signal space, the transceiver including:
a sampling unit for generating a sampled receive signal from a receive signal;
a deriving unit for deriving an interference level threshold on the basis of an iterative statistical analysis of the sampled receive signal;
an identifying unit for identifying an interfered portion of the signal space on the basis of a comparison of the sampled receive signal and the interference level threshold; and
a transmit resource allocation unit for reducing transmit resources from the interfered portion of the signal space.

14. The transceiver of claim 15, wherein the deriving unit is configured to perform an iterative procedure including tasks of:
calculating the mean of the sampled receive signal;
generating the interference level threshold by using the mean, and a predefined reliability factor characterizing statistics of a non-interfered portion in the sampled receive signal; and
neglecting a portion of the sampled receive signal, the portion lying above the interference level threshold.

15. The transceiver of claim 13, further including a receive resource allocation unit connected to the identifying unit, for reducing receive resources from the interfered portion of the signal space.

16. The transceiver of claim 13, wherein the transmit resource allocation unit is configured to perform at least one of the tasks selected from a group including: attenuating a portion of a transmit signal, the portion being located in the interfered portion of the signal space; excising a portion of a transmit signal, the portion being located in the interfered portion of the signal space.

17. The transceiver of claim 13, further including a transmitting unit for transmitting information on the interfered portion of the signal space to a second transceiver.

18. The transceiver of claim 13, wherein the transmit resource allocation unit is configured to allocate transmit resources to a non-interfered portion of the signal space.

19. The transceiver of claim 13, wherein the signal space includes at least one dimension selected from the group comprising: a spatial dimension, a temporal dimension, a frequency dimension, a fractional frequency dimension.

20. A transceiver of a telecommunications system, wherein signals are transmitted over a signal space, the transceiver including:
a receiving unit for receiving information on an interfered portion of the signal space from a second transceiver; and
a transmit resource allocation unit for reducing transmit resources from the interfered portion of the signal space on the basis of the information.

21. The transceiver of claim 20, further including a receive resource allocation unit connected to the receiving unit, for reducing receive resources from the interfered portion of the signal space on the basis of the information.

22. The transceiver of claim 20, wherein the transmit resource allocation unit is configured to perform at least one task selected from a group comprising: attenuating a portion of a transmit signal, the portion being located in the interfered portion of the signal space; excising a portion of the transmit signal, the portion being located in the interfered portion of the signal space.

23. The transceiver of claim 20, wherein the transmit resource allocation unit is configured to allocate transmit resources to a non-interfered portion of the signal space.

24. The transceiver of claim 20, wherein the signal space includes at least one dimension selected from the group comprising: a spatial dimension, a temporal dimension, a frequency dimension, a fractional frequency dimension.

25. A telecommunications system, wherein signals are transmitted over a signal space, the telecommunications system including:
generating means for generating a sampled receive signal from a receive signal;
deriving means for deriving an interference level threshold on the basis of an iterative statistical analysis of the sampled receive signal;
identifying means for identifying an interfered portion of the signal space on the basis of a comparison of the sampled receive signal and the interference level threshold; and
reducing means for reducing transmit resources from the interfered portion of the signal space.

26. The telecommunications system of claim 25, wherein the deriving means include:
calculating means for calculating the mean of the sampled receive signal;
generating means for generating the interference level threshold by using the mean, and a predefined reliability factor characterizing statistics of a non-interfered portion in the sampled receive signal; and
neglecting means for neglecting a portion of the sampled receive signal, the portion lying above the interference level threshold, in a succeeding iteration step,
wherein the combination of the calculating means, generating means, and neglecting means acts in an iterative manner.

27. A computer program for executing a computer process in a telecommunications system, wherein signals are transmitted over a signal space, the computer process comprising the steps of:
receiving as input a sampled receive signal generated from a receive signal;
deriving an interference level threshold on the basis of an iterative statistical analysis of the sampled receive signal; and
identifying an interfered portion of the signal space on the basis of a comparison of the sampled receive signal and the interference level threshold; and
outputting information on the interfered portion of the signal space.

28. A computer program of claim 27, wherein the computer process further includes the iterative steps of:
calculating the mean of the sampled receive signal;
generating the interference level threshold by using the mean, and a predefined reliability factor characterizing statistics of a non-interfered portion in the sampled receive signal; and
neglecting a portion of the sampled receive signal, the portion lying above the interference level threshold, in a succeeding iteration step.

29. A computer program of claim 27, wherein the computer process further includes the step of reducing transmit resources from the interfered portion of the signal space.

30. A computer program for executing a computer process in a telecommunications system, wherein signals are transmitted over a signal space, the computer process comprising the steps of:
receiving as input information on an interfered portion of the signal space; and
reducing transmit resources from the interfered portion of the signal space on the basis of the information.

31. A computer program of claim 30, wherein the computer process further includes the step of allocating transmit resources to a non-interfered portion of the signal space.
